(19) United States
(12) Patent Application Publication
(10) Pub. No.: US 2013/0127254 A1
(43) Pub. Date: May 23, 2013

(54) CONTACTLESS POWER SUPPLYING SYSTEM

(71) Applicant: PANASONIC CORPORATION, Osaka (JP)

(72) Inventors: Nobuhiro MIICHI, Hyogo (JP); Tomoharu NAKAHARA, Hyogo (JP); Satoshi HYODO, Hyogo (JP)

(73) Assignee: PANASONIC CORPORATION, Osaka (JP)

(21) Appl. No.: 13/658,853

(22) Filed: Oct. 24, 2012

(30) Foreign Application Priority Data
Jul. 25, 2011 (JP) 2011-162254

(51) Int. Cl. H01F 38/14

(52) U.S. Cl. CPC H01F 38/14
USPC 307/104

(57) ABSTRACT

The position and orientation of a power receiving coil are estimated based on a presence detection level of each power supplying coil. A power supplying pattern in which an output of the power receiving device becomes maximal is selected for the position and orientation and power is supplied in the power supplying pattern. Accordingly, power can be supplied to the power receiving device with high efficiency regardless of the position and orientation of the power receiving coil.

### BACKGROUND ART

The present invention relates to a contactless power supplying system.

In the prior art, there is a contactless power supplying system that supplies power in a contactless manner from a power supplying device to a power receiving device (for example, refer to Japanese Laid-Open Patent Publication No. 2003-204637). The power supplying device supplies power from a power source in a contactless manner to the power receiving device. When receiving power from the power supplying device, the power receiving device supplies the power to a main body of an electric appliance.

To improve convenience for a user, a free layout type contactless power supplying system has recently been developed. The system allows for a power receiving device to be arranged at any location on an upper surface (power supplying surface) of a power receiving device. In this system, the power receiving device does not need to be arranged at any particularly determined position as long as it is on a power supplying surface of the power supplying device.

A plurality of primary coils are arranged along the power supplying surface in the power supplying device of this system. The power supplying device excites the primary coils to generate magnetic fluxes. The magnetic fluxes cause electromotive force to be generated at a secondary coil, which is arranged in the power receiving device. This supplies from the power supplying device to the power receiving device (for example, refer to Japanese Laid-Open Patent Publication No. 2008-5573).

When starting the power supply, the power supplying device performs presence detection of detects the presence of the power receiving device on the power supplying surface and the position of the power receiving device. Specifically, the power supplying device first sequentially supplies current to each of the primary coils and monitors the present current at the primary coils. When the power receiving device is present in a magnetic flux direction of the primary coil, the primary coil magnetically couples to the secondary coil and changes the current flowing to the primary coil. Based on the change in current, the power supplying device can detect the primary coils that are located near the power receiving device. The power supplying device supplies current only to the primary coils in the area that is determined as where the power receiving device is present. The prevents unnecessary power from being supplied to primary coils in areas in which the power receiving device is not present.

### SUMMARY OF THE INVENTION

In the free layout type contactless power supplying system, current is supplied to all of the primary coils in the area determined as where the power receiving device is present. Actually, however, the output power of the power receiving device would increase and improve the power supplying efficiency if the current were to be supplied only to some of the primary coils in the above-described area rather than to all of the primary coils in the area. It is considered that this is because the magnetic fluxes generated from the primary coils interfere with and cancel each other.

It is an object of the present invention to provide a contactless power supplying system that can improve the power supplying efficiency by changing a power supplying pattern of the primary coils.

### RESOLUTION TO THE PROBLEM

To achieve the above problem, a contactless power supplying system according to the present invention is provided with a power supplying device including a power supplying surface and a plurality of power supplying coils arranged along the power supplying surface. Each of the power supplying coils generates an alternating magnetic flux when supplied with alternating current. A power receiving device includes a power receiving coil that generates inductive power supplied to a load based on the alternating magnetic flux when arranged on the power supplying surface. The power supplying device includes a presence detection unit that detects whether or not the power receiving device is present opposing each of the power supplying coils. A position-orientation estimation unit estimates position and orientation of the power receiving coil relative to the power supplying surface based on a detection result of the presence detection unit. A memory stores a first table showing a relationship of a plurality of power supplying patterns, which correspond to the position and orientation of the power receiving coil in the power receiving device on the power supplying surface, and a power value of the inductive power generated by the power receiving coil in each of the power supplying patterns. A power supply control unit selects the power supplying pattern having the highest power supplying efficiency in accordance with the position and orientation of the power receiving coil estimated by the position-orientation estimation unit based on the first table. The power supply control unit supplies power in the selected power supplying pattern.

### EFFECT OF THE INVENTION

In a contactless power supplying system, the present invention changes a power supplying pattern of the primary coils and improves the power supplying efficiency.

### BRIEF DESCRIPTION OF THE DRAWINGS

FIG. 1 is a diagram showing the structure of a contactless power supplying system;

FIG. 2 is a perspective view showing the contactless power supplying system;

FIG. 3 is a table stored in a memory in a first embodiment;

FIG. 4 is a schematic diagram showing the distribution of presence detection levels in power supplying coils L1 of a first embodiment;

FIG. 5 is a schematic view showing the presence detection level calculated in the first embodiment and the presence detection level in a third arrangement pattern stored in the memory;

FIG. 6 shows a table showing a difference degree R of each arrangement pattern in the first embodiment;

FIG. 7 is a flowchart executed by a common control circuit in the first embodiment;

FIG. 8(a) is a diagram showing an arrangement state of a power receiving coil L3 in a second embodiment, FIG. 8(b) is a view showing a presence detection level of each power supplying coil L1, and FIG. 8(c) is a diagram showing a selected area;

FIG. 9 shows a table stored in a memory in a third embodiment;

FIG. 10 shows a table stored in a memory in a fourth embodiment;

FIGS. 11(a) to 11(d) are diagrams showing the shapes of a power receiving coil L3 and a secondary verification coil L4 in a fifth embodiment;

FIG. 12(a) is a diagram showing the presence detection level of each power supplying coil L1, FIG. 12(b) is a view showing an arrangement state of the secondary verification coil L4, and FIG. 12(c) is a view showing an arrangement state of the power receiving coil L3; and

FIG. 13 shows a table stored in a memory of the fifth embodiment.

### DETAILED DESCRIPTION OF THE PREFERRED EMBODIMENTS

### First Embodiment

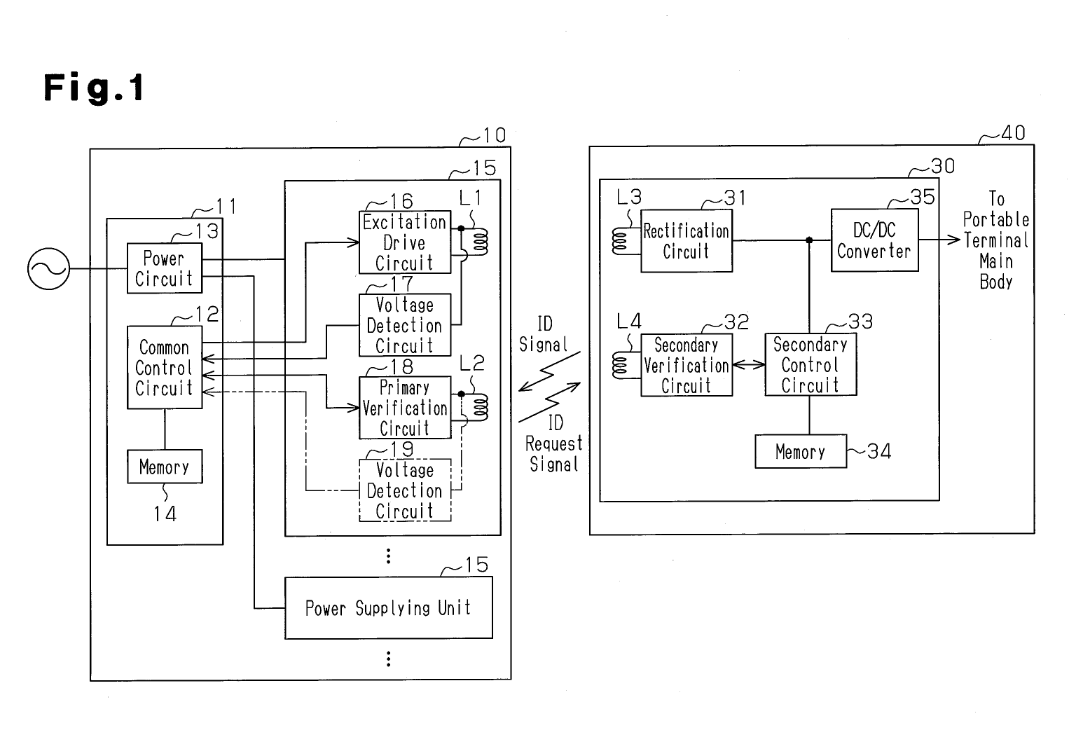

A first embodiment of a contactless power supplying system according to the present invention will now be described with reference to FIGS. 1 to 7.

As shown in FIG. 1, the contactless power supplying system includes a power supplying device 10 and a power receiving device 30. In the present example, the power receiving device 30 is incorporated in a portable terminal 40. The structure of the power supplying device 10 and the power receiving device 30 will now be described.

Power Supplying Device

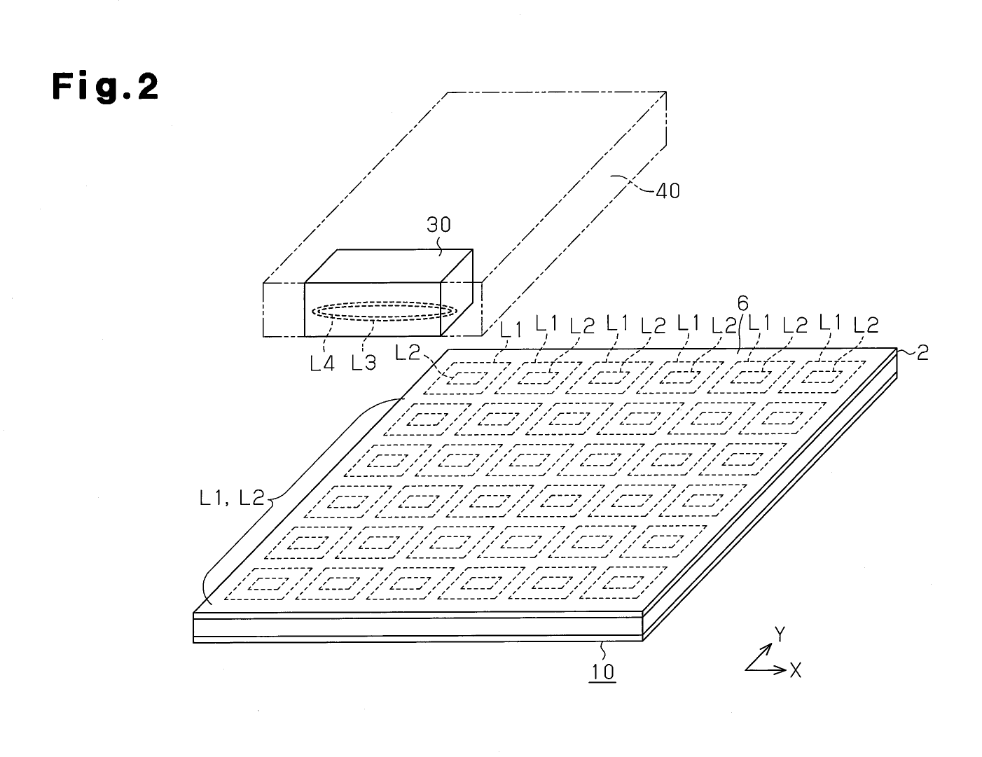

As shown in FIG. 2, the power supplying device 10 is enclosed by a flat frame 2. The frame 2 includes an upper surface defining a power supplying surface 6 on which the portable terminal 40 is set.

As shown by broken lines in FIG. 2, a total of thirty-six sets of coils are arranged in the frame 2 over the entire region of the power supplying surface 6. One set of coils includes a power supplying coil L1 and a primary verification coil L2. The sets of coils are arranged in a matrix form of six rows and six columns on the power supplying surface 6.

As shown in FIG. 1, the power supplying device 10 includes a single common unit 11, and a plurality of (thirty-six in the present example) power supplying units 15 connected to the common unit 11.

The common unit 11 includes a power supply circuit 13, a common control circuit 12, and a nonvolatile memory 14.

The power supply circuit 13 converts power from an external power supply to an appropriate direct current voltage and supplies the DC voltage as operational power to each power supplying unit 15 and the common unit 11.

The common control circuit 12 is formed by a microcomputer and centrally controls the power supplying units 15.

Each power supplying unit 15 includes an excitation drive circuit 16, a voltage detection circuit 17, and a primary verification circuit 18. The power supplying coil L1 is connected to the excitation drive circuit 16, and the primary verification coil L2 is connected to the primary verification circuit 18.

The voltage detection circuit 17 is connected to the power supplying coil L1. The voltage detection circuit 17 detects the voltage of the power supplying coil L1 and outputs the detection result to the common control circuit 12.

The common control circuit 12 controls the operation of the excitation drive circuit 16 by outputting a command signal. When receiving the command signal, the excitation drive circuit 16 generates high-frequency current (alternating current) and supplies the generated current to the power supplying coil L1. This excites the power supplying coil L1.

The common control circuit 12 sequentially supplies the high-frequency current to the power supplying coils L1 and performs presence detection of whether or not an object is present at a periphery of the power supplying coil L1 based on the detection result of the voltage detection circuit 17. The time for supplying the high-frequency current to each power supplying coil L1 in the presence detection is set to a short time so that an increase in the temperature of an object on the power supplying surface caused by the current is substantially undetected. The presence detection will be described in detail later. The common control circuit 12 and the voltage detection circuit 17 form a presence detection unit.

When determining that a object is present in the periphery of the power supplying coil L1, the common control circuit 12 generates an ID request signal, and outputs the generated signal to the primary verification circuit 18. The primary verification circuit 18 modulates the ID request signal and transmits the modulated signal through wireless communication via the primary verification coil L2.

When receiving an ID signal from the power receiving device 30 using electromagnetic induction, the primary verification coil L2 outputs the received signal to the primary verification circuit 18. The primary verification circuit 18 demodulates the ID signal and outputs the demodulated signal to the common control circuit 12. The common control circuit 12 verifies an ID code contained in the ID signal with an ID code stored in the memory 14. The common control circuit 12 assumes the object is the authentic power receiving device 30 when determining that the ID codes are in conformance and executes the power supply.

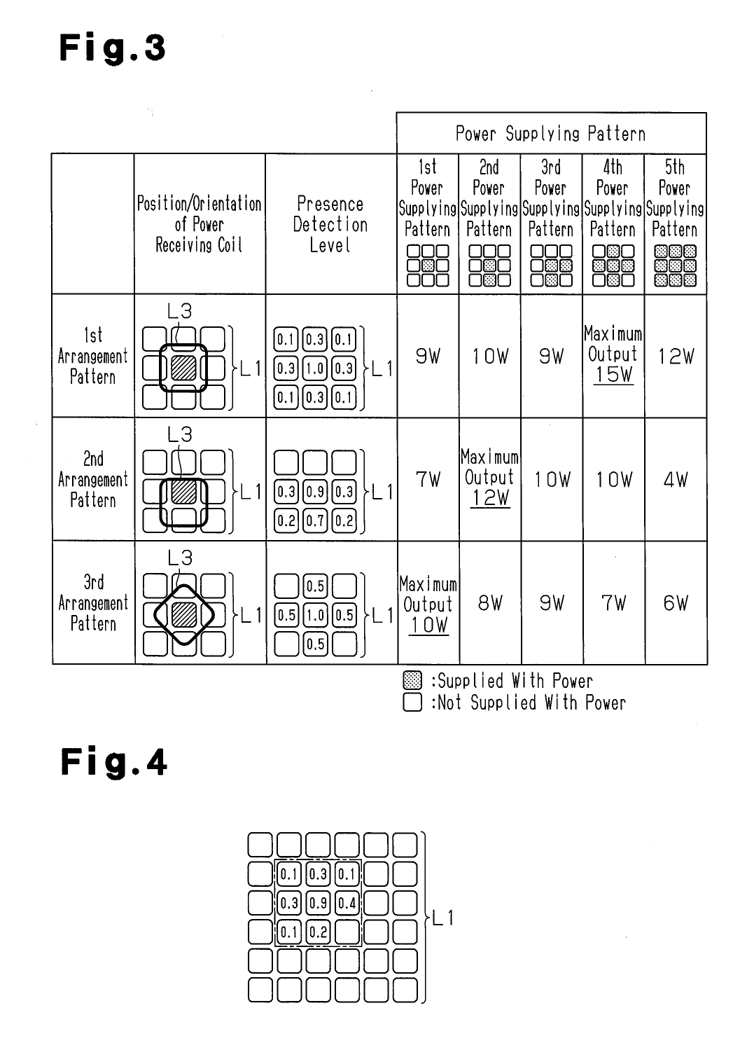

The memory 14 stores a table shown in FIG. 3 and the ID code unique to the power receiving device 30 that is registered in advance. The table shows a presence detection level of each power supplying coil L1 in first to third arrangement patterns in which the position and orientation of a power receiving coil L3 differ, and an output power of the power receiving device 30 when power is supplied in first to fifth power supplying patterns in each arrangement pattern. The common control circuit 12 forms a position-orientation estimation unit and a power supply control unit.

The presence detection will now be described in detail.

The common control circuit 12 determines whether or not an object (power receiving coil L3) is present in the periphery of a power supplying coil L1 and estimates the position and orientation of the object based on the detection result of the voltage detection circuit 17. When the object is present at the periphery of a power supplying coil L1, the power supplying coil L1, when excited, magnetically couples with the relevant object. This increases the impedance in the power supplying coil L1. Thus, the voltage of the power supplying coil L1 decreases. The voltage of the power supplying coil L1 becomes a value corresponding to the degree of magnetic coupling of the power receiving coil L3 and the power supplying coil L1 when the power receiving device 30 is arranged as the object. The common control circuit 12 calculates the degree of magnetic coupling of the power receiving coil L3 relative to the power supplying coil L1 as a presence detection level based on the detection result of the voltage detection circuit 17. The presence detection level is represented by an actual number. FIG. 4 shows the distribution of presence detection levels for the power supplying coils L1. In this drawing, the presence detection level is “0.0” for the power supplying coil L1 that do not indicate a number. This also applies to other drawings.

If the power receiving coil L3 is not overlapping the power supplying coil L1 at all, the presence detection level is calculated as “0.0” since the coils L1 and L3 are not magnetically coupled. If the power receiving coil L3 is overlapping the entire power supplying coil L1, the degree of the magnetic coupling between the coils L1 and L3 becomes maximal and the presence detection level is calculated as “1.0”.

The common control circuit 12 calculates the presence detection level for each power supplying coil L1 when performing the presence detection. The common control circuit 12 estimates the position and orientation of the power receiving coil L3 based on the comparison between the calculated presence detection level and the presence detection level of the first to third arrangement patterns stored in the memory 14.

As shown at the left side in FIG. 3, the first to third arrangement patterns are the position and orientation of the power receiving coil L3 with respect to a total of nine power supplying coils L1 in “three rows×three columns”. In this example, the power supplying coil L1 and the power receiving coil L3 are both formed to be square, and the power receiving coil L3 is formed to be larger than the power supplying coil L1. When the relationship in size of the power receiving coil L3 and the power supplying coil L1 changes, the number of power supplying coils L1 facing one power receiving coil L3 also changes.

In the first arrangement pattern, the power receiving coil L3 is positioned at the middle of the “three rows×three columns” in correspondence with the power supplying coil L1 located at the middle of the power receiving coil L3. In the second arrangement pattern, the power receiving coil L3 is arranged so that the upper side of the power receiving coil L3 comes into contact with the upper side of the middle power supplying coil L1 and the middle supplying coil L1 is included at the laterally middle part of the power receiving coil L3 as viewed in FIG. 3. In the third arrangement pattern, the power receiving coil L3 is arranged at a position rotated by 45° about a coil axis from the first arrangement pattern.

A method for estimating the position and orientation of the power receiving coil L3 based on a plurality of calculated presence detection levels will now be described.

As shown in FIG. 4, the common control circuit 12 selects the largest presence detection level from a plurality of presence detection levels. In this example, “0.9”, which is the largest presence detection level, is selected. The common control circuit 12 selects the power supplying coil L1 of the selected presence detection level and the eight power supplying coils L1 surrounding the relevant power supplying coil L1. In other words, the “three rows×three columns” are selected centered about the power supplying coil L1 having with the largest presence detection level.

A difference degree R of the selected presence detection level of each power supplying coil L1 from each presence detection level in the first to third arrangement patterns stored in the memory 14 is calculated from the following equation (1).

$$\begin{matrix}[ Equation 1 ] & \\ R = {\sum }_{i = 0}^{2} {\sum }_{j = 0}^{2} \vert I ( i , j ) - T ( i , j ) \vert & ( 1 )\end{matrix}$$

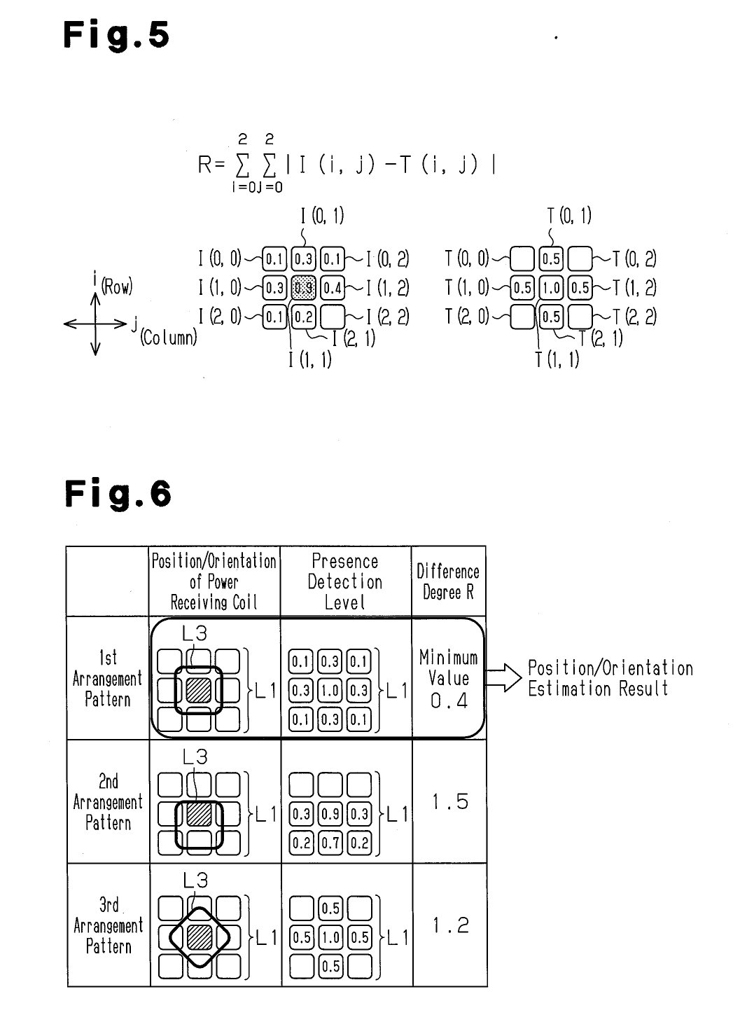

In equation (1), “I” is the calculated presence detection level of the power supplying coil L1, and “T” is the presence detection level stored in the memory 14. Furthermore, i represents the row and j represents the column. As shown in FIG. 5, a column indicates the position in the left to right direction in the matrix elements, and a row indicates the position in the up to down direction in the matrix elements.

When calculating the difference degree R, the absolute value of a value obtained by subtracting T(0, 0) from I(0, 0) is first obtained. The absolute value of a value obtained by subtracting T(0, 1) from I(0, 1) is then obtained. This is performed over a total of nine times, and then the obtained absolute values are added. The difference degree R is derived in this manner. It is presumed that the power receiving coil L3 is arranged at a position and orientation more approximate to an arrangement pattern when the difference degree R decreases. The difference degree R is calculated as the Sum of Squared Difference (SAD) as indicated in equation FIG. 1 but may be calculated by Sum of Squared Difference (SSD). Furthermore, a normalized cross-correlation (NCC) value may be calculated as a similarity degree instead of the difference degree, and the power receiving coil L3 may be presumed as being arranged at a position and orientation where the similarity degree becomes the largest.

As shown in FIG. 6, the common control circuit 12 calculates the difference degree R for the first to third arrangement patterns. In the present example, the difference degree R in the first arrangement pattern is “0.4”, the difference degree R in the second arrangement pattern is “1.5”, and the difference degree R in the third arrangement pattern is “1.2”. The common control circuit 12 estimates that the present position and orientation of the power receiving coil L3 are close to the first arrangement pattern, which corresponds to the smallest one of the three difference degrees R.

The common control circuit 12 supplies power in a power supplying pattern in which the output power of the power receiving device 30 becomes maximal among the first to fifth power supplying patterns based on the estimated result of the position and orientation of the power receiving coil L3. The power supplying efficiency becomes maximal when the output of the power receiving device 30 becomes maximal. The power supplying efficiency is calculated based on the amount of power received per fixed time.

As shown at the right side in FIG. 3, the first power supplying pattern is a pattern in which the power is supplied only to the middle power supplying coil L1 in “three rows×three columns”. The second power supplying pattern is a pattern in which the power is supplied to the middle power supplying coil L1 and the power supplying coil L1 at the lower side of the middle power supplying coil L1 in the “three rows×three columns”. The third power supplying pattern is a pattern in which the power is supplied to the middle power supplying coil L1 and the power supplying coils L1 at the lower side and right side of the middle power supplying coil L1 in the “three rows×three columns”. The fourth power supplying pattern is a pattern in which the power is supplied to a total of five power supplying coils arranged in the form of a cross with the middle power supplying coil L1 located at the center in “three rows×three columns”. The fifth power supplying pattern is a pattern in which the power is supplied to all nine power supplying coils L1 in “three rows×three columns”. In any one of the power supplying patterns, each power supplying coil L1 is supplied with the same power.

If the power receiving coil L3 is arranged in the first arrangement pattern, the output of the power receiving device 30 becomes maximal at 15 W when the power is supplied in the fourth power supplying pattern. The common control circuit 12 thus estimates that the arrangement and the orientation of the power receiving coil L3 are close to the first arrangement pattern and performs power supply in the fourth power supplying pattern.

If the power receiving coil L3 is arranged in the second arrangement pattern, the output of the power receiving device 30 becomes maximal at 12 W when the power is supplied in the second power supplying pattern. The common control circuit 12 thus estimates that the position and orientation of the power receiving coil L3 are close to the second arrangement pattern and performs power supply in the second power supplying pattern.

If the power receiving coil L3 is arranged in the third arrangement pattern, the output of the power receiving device 30 becomes maximal at 10 W when the power is supplied in the first power supplying pattern. The common control circuit 12 thus estimates that the position and orientation of the power receiving coil L3 are close to the third arrangement pattern and performs power supply in the first power supplying pattern.

The presence detection level in each arrangement pattern stored in the memory 14 is obtained through experiments. In the same manner, the output power in each power supplying pattern stored in the memory 14 is obtained through experiments. In the experiments, the power is actually supplied in the first to fifth power supplying patterns with the power receiving coil L3 arranged in each arrangement pattern. The output power of the power receiving device 30 in this state is stored.

Power Receiving Device

As shown in FIG. 1, the power receiving device 30 includes a rectifier circuit 31, a secondary verification circuit 32, a secondary control circuit 33, a memory 34, and a DC/DC converter 35. The power receiving coil L3 is connected to the rectifier circuit 31, and a secondary verification coil L4 is connected to the secondary verification circuit 32.

The power receiving coil L3 outputs the power induced by the magnetic flux from the power supplying coil L1 to the rectifier circuit 31. The rectifier circuit 31 rectifies the AC power induced by the power receiving coil L3. The DC/DC converter 35 converts the DC voltage from the rectifier circuit 31 to a value appropriate for the operation of the portable terminal 40. The DC voltage is used, for example, to charge a rechargeable battery (not shown), which is an operational power source for the portable terminal 40.

The secondary control circuit 33 is formed by a microcomputer and operates when receiving some of the power from the rectifier circuit 31. The memory 34 stores an ID code unique to the power receiving device 30.

When receiving an ID request signal from the primary verification coil L2 using electromagnetic induction, the secondary verification coil L4 outputs the received signal to the secondary verification circuit 32. The secondary verification circuit 32 demodulates the ID request signal and outputs the demodulated signal to the secondary control circuit 33. The secondary control circuit 33 generates an ID signal including the ID code stored in the memory 34 when recognizing the ID request signal and outputs the generated signal to the secondary verification circuit 32. The secondary verification circuit 32 modulates the ID signal, and transmits, through wireless communication, the modulated signal through the secondary verification coil L4.

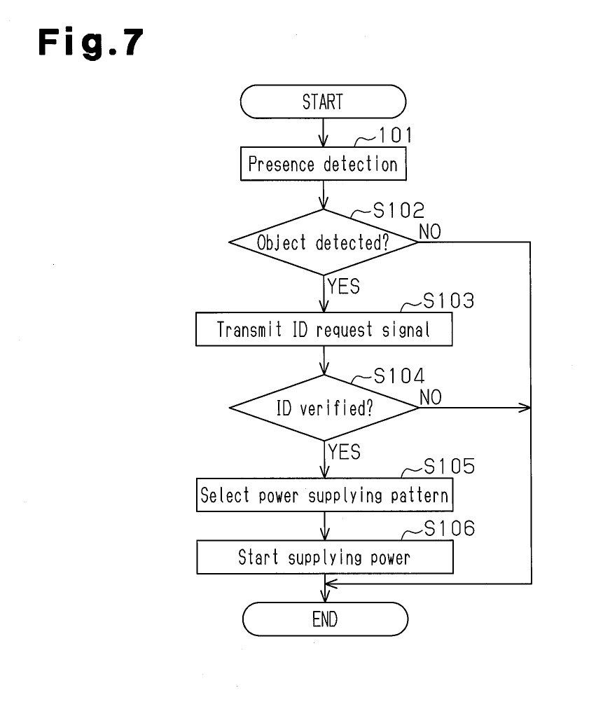

A procedures of the processing performed by the common control circuit 12 will now be described with reference to the flowchart of FIG. 7. This flowchart is executed in fixed cycles.

First, the common control circuit 12 performs the presence detection by sequentially supplying current to the power supplying coils L1 (S101) and determines the presence of an object (S102). The common control circuit 12 ends the processing when the presence of an object is not detected (NO in S102).

When the presence of an object is detected (YES in S102), the common control circuit 12 transmits the ID request signal (S103). The common control circuit 12 verifies the ID code contained in the received ID signal with the ID code stored in its memory 14 (S104). The common control circuit 12 ends the processing when determining that the ID codes are not in conformance (NO in S104). This prevents power from being supplied to a device other than the authentic power receiving device 30. When determining that the ID codes are in conformance (YES in S104), the common control circuit 12 selects the power supplying pattern (S105) in which the output power of the power receiving device 30 becomes maximal based on the position and orientation of the power receiving coil L3 estimated through the calculation and comparison of the difference degree R. The common control circuit 12 then starts supplying power to the power supplying coil L1 in the selected power supplying pattern (S106). This ends the processing performed by the common control circuit 12.

The first embodiment described above has the advantages described below.

(1) The position and orientation of the power receiving coil L3 are estimated based on the presence detection level of each power supplying coil L1. The power supplying pattern in which the output of the power receiving device 30 becomes maximal at the position and orientation is then selected, and the power is supplied in the power supplying pattern. Therefore, the power is supplied to the power receiving device 30 with high efficiency regardless of the position and orientation of the power receiving coil L3.

(2) The arrangement pattern of the power receiving coil L3 is estimated by comparing the calculated difference degrees R. The arrangement pattern close to the actual position and orientation of the power receiving coil L3 is thus estimated through a simple process.

### Second Embodiment

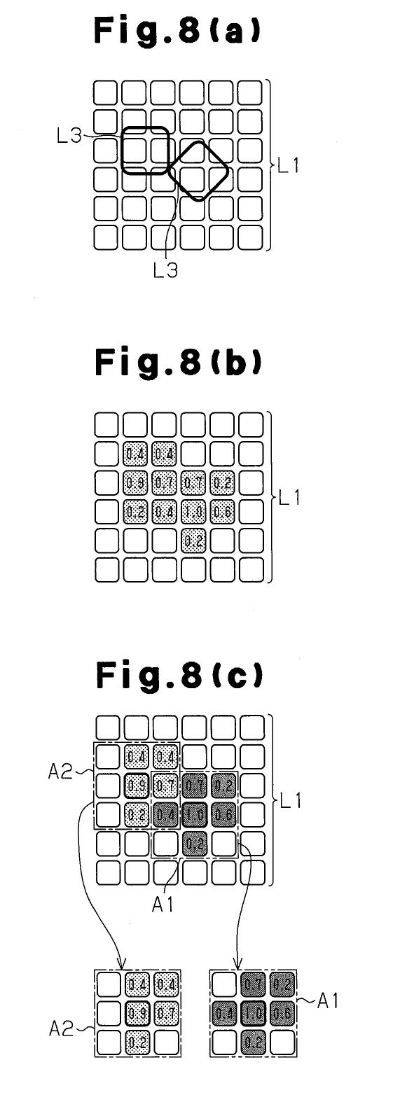

A second embodiment of a contactless power supplying system according to the present invention will now be described with reference to FIG. 8. The contactless power supplying system of the second embodiment differs from the first embodiment in that power is supplied in an appropriate power supplying pattern even if a plurality of power receiving coils L3 are adjacently arranged. The description hereafter will focus on the differences from the first embodiment. The contactless power supplying system of the second embodiment has substantially the same structure as the contactless power supplying system of the first embodiment shown in FIG. 1.

The common control circuit 12 determines the presence detection level of each power supplying coil L1 and determines whether or not the number of power supplying coils L1 that have a presence detection level greater than or equal to a threshold T1 among the power supplying coils L1 is greater than or equal to a threshold. The threshold T, which can be set to any value so that the presence of the power receiving coil L3 can be detected and so as to be greater than the noise level, is set to, for example, T1=0.1.

In view of the size of the power receiving coil L3 in the present example, if one power receiving coil L3 is arranged on the power supplying surface 6, the number of power supplying coils L1 having presence detection levels greater than or equal to the threshold T1 is assumed to be nine at maximum. Therefore, the threshold is set to, for example, ten. In other words, the threshold is set to increase as the size of the power receiving coil L3 increases.

The common control circuit 12 determines that one power receiving coil L3 is arranged on the power supplying surface 6 when detecting that the number of power supplying coils L1 that have presence detection levels greater than or equal to the threshold T1 among the power supplying coils L1 is less than the threshold. Then, the common control circuit 12 estimates the orientation and the position of the power receiving coil L3 and supplies power in the power supplying pattern in which the output becomes maximal based on the estimation result through the same processing as the first embodiment.

As shown in FIG. 8(a), a case in which two power receiving coils L3 are adjacently arranged in different orientations will be described. In this case, as shown in FIG. 8(b), the common control circuit 12 determines that the number of power supplying coils L1 having presence detection levels greater than or equal to the threshold T1 among the power supplying coils L1 is greater than or equal to the threshold. The common control circuit 12 then selects the two top power supplying coils L1 having the highest presence detection levels among all of the presence detection levels. That is, as shown in FIG. 8(c), the power supplying coil L1 in which the presence detection level is “1.0” and the power supplying coil L1 in which the presence detection level is “0.9” are selected. The common control circuit 12 selects the “three rows×three columns” (first area A1) having the power supplying coil L1 with the presence detection level of “1.0” located in the center and also selects the “three rows×three columns” (second area A2) having the power supplying coil L1 with the presence detection level of “0.9” located at the center. In this case, the presence level of the portion where the first area A1 and the second area A2 overlap is included in the area closer in distance of the two power supplying coils L1 serving as the center of the respective areas A1, A2. In the present example, the presence detection level (“0.4”) of the power supplying coil L1 located at the left side of the power supplying coil L1 having the presence detection level of “1.0” is included in the first area A1. The presence detection level (“0.7”) of the power supplying coil L1 located at the right side of the power supplying coil L1 having the presence detection level of “0.9” is included in the second area A2.

In the same manner as the first embodiment, the common control circuit 12 estimates the one of the arrangement patterns that the power receiving coil L3 is close to based on the difference degree R calculated from the presence detection level of the areas A1 and A2 and supplies power in the power supplying pattern in which the output of the power receiving device 30 becomes maximal in the estimated arrangement pattern.

The second embodiment described above has the following advantage in addition to advantages (1) and (2) of the first embodiment.

(3) Even if two power receiving coils L3 are adjacently arranged, the position and orientation of each power receiving coil L3 are estimated, and power is supplied in the power supplying pattern in which the output of each power receiving device 30 becomes maximal.

### Third Embodiment

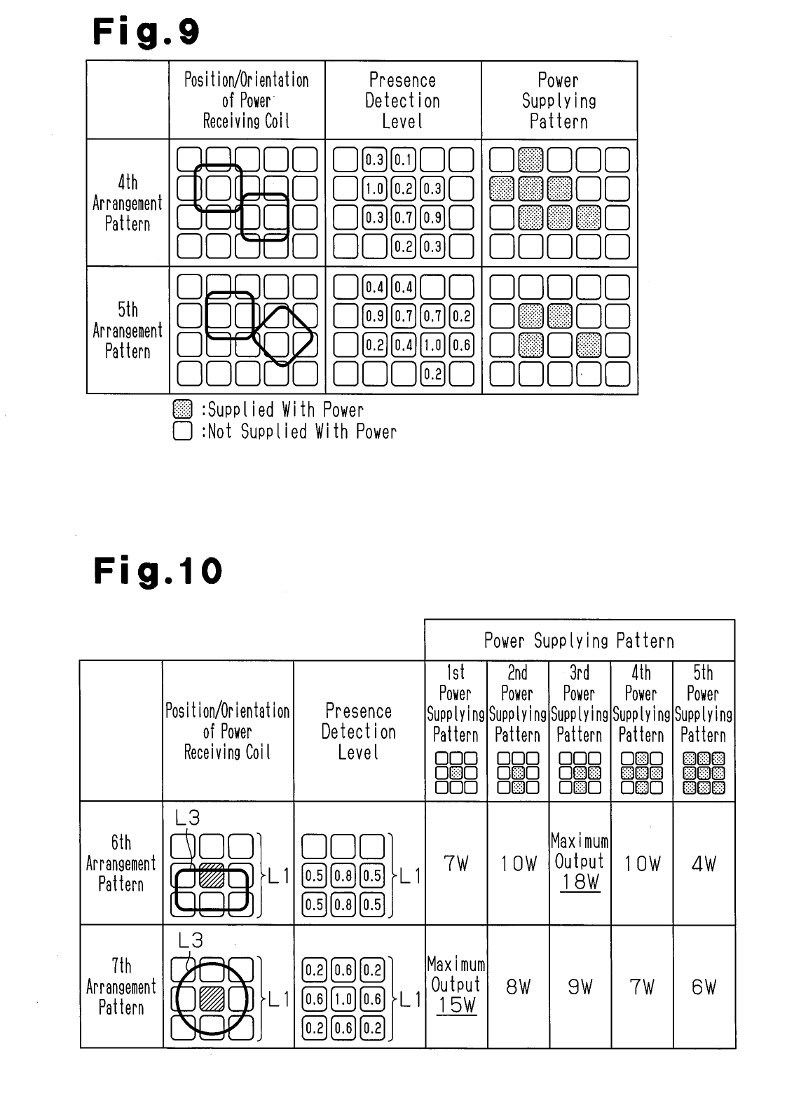

A third embodiment of a contactless power supplying system according to the present invention will now be described with reference to FIG. 9. The contactless power supplying system of the third embodiment differs from the first embodiment in that a presence detection level of when a plurality of power receiving coils L3 are adjacently arranged and a power supplying pattern in which the output power of the power receiving device becomes maximal are stored in advance. The description hereafter will focus on the differences from the first embodiment. The contactless power supplying system of the third embodiment has substantially the same structure as the contactless power supplying system of the first embodiment shown in FIG. 1.

As shown in FIG. 9, the memory 14 stores, in advance, the presence detection level of each power supplying coil L1 in fourth and fifth arrangement patterns in which the plurality of power receiving coils L3 are adjacently arranged, and the power supplying pattern in which the output of the power receiving device 30 becomes maximal in the fourth and fifth arrangement patterns, in addition to the data of FIG. 3. The common control circuit 12 uses the presence detection level of each power supplying coil L1 in the fourth arrangement pattern and the fifth arrangement pattern to calculate the difference degree R in the same manner as the first to third arrangement patterns in the first embodiment. When determining that the difference degree R in the fourth arrangement pattern is the smallest, the common control circuit 12 estimates that the plurality of power receiving coils L3 are arranged in the fourth arrangement pattern and supplies power to the power supplying coil L1 in the power supply pattern shown at the right side in the upper part of FIG. 9. In the same manner, when determining that the difference degree R in the fifth arrangement pattern is the smallest, the common control circuit 12 estimates that the plurality of power receiving coils L3 are arranged in the fifth arrangement pattern, and supplies power to the power supplying coil L1 in the power supply pattern shown on the right side in the lower part of FIG. 9. The output power can be maximized in the power receiving device 30 by supplying power in such power supplying patterns.

The third embodiment described above has the following advantage in addition to advantage (3) of the second embodiment.

(4) Even if the plurality of power receiving coils L3 are adjacently arranged, the power supplying pattern in which the output of the power receiving device 30 becomes maximal is determined without calculating the difference degree R for every arranged power receiving coil L3.

### Fourth Embodiment

A fourth embodiment of a contactless power supplying system according to the present invention will now be described with reference to FIG. 10. The description hereafter will focus on differences from the first embodiment.

As shown in FIG. 10, the memory 14 stores, in advance, the presence detection level of each power supplying coil L1 when the power receiving coils L3 having different shapes are arranged in sixth and seventh arrangement patterns, and the power supplying pattern in which the output of the power receiving device 30 becomes maximal in the sixth and seventh arrangement patterns, in addition to the data of FIGS. 3 and 9.

As shown in the upper part of FIG. 10, the power receiving coil L3 of the sixth arrangement pattern is formed to have a rectangular shape with a long side extending along the left to right direction and is located at a lower side of a middle one of power supplying coils L1 arranged in “three rows×three columns”. As shown in the lower part of FIG. 10, the power receiving coil L3 of the seventh arrangement pattern is formed to have a circular shape and is positioned at the middle of the power supplying coils L1 arranged in “three rows×three columns”. In the seventh arrangement pattern, the arrangement position of the power receiving coil L3 is the same as the first arrangement pattern (see FIG. 3). However, the presence detection level differs from that of the first arrangement pattern since the shape of the power receiving coil L3 differs from that in the first arrangement pattern.

In the same manner as the first embodiment, the common control circuit 12 uses the presence detection level of each arrangement pattern to calculate the difference degree R. When determining that the difference degree R in the sixth arrangement pattern is the smallest, the common control circuit 12 supplies power to the power supplying coil L3 in the third power supplying pattern so that the output becomes maximal. The output of a maximum of 18 W is thus obtained in the power receiving device 30.

When determining that the difference degree R in the seventh arrangement pattern is the smallest, the common control circuit 12 supplies power to the power supplying coil L3 in the first power supplying pattern so that the output becomes maximal. The output of a maximum of 15 W is thus obtained in the power receiving device 30. In other words, not only the position and orientation of the power receiving coil L3, but also the shape of the power receiving coil L3 can be estimated through the difference degree R. Therefore, the power can be supplied in the power supplying pattern conforming to the shape of the power receiving coil L3.

The fourth embodiment described above has the advantages described below.

(5) The presence detection level of power receiving coils L3 having different shapes and the power supplying pattern in which the output of the power receiving device 30 becomes maximal are stored in advance. Thus, the power is supplied to the power supplying pattern in which the output becomes maximal even if the shape of the power receiving coil L3 is different.

### Fifth Embodiment

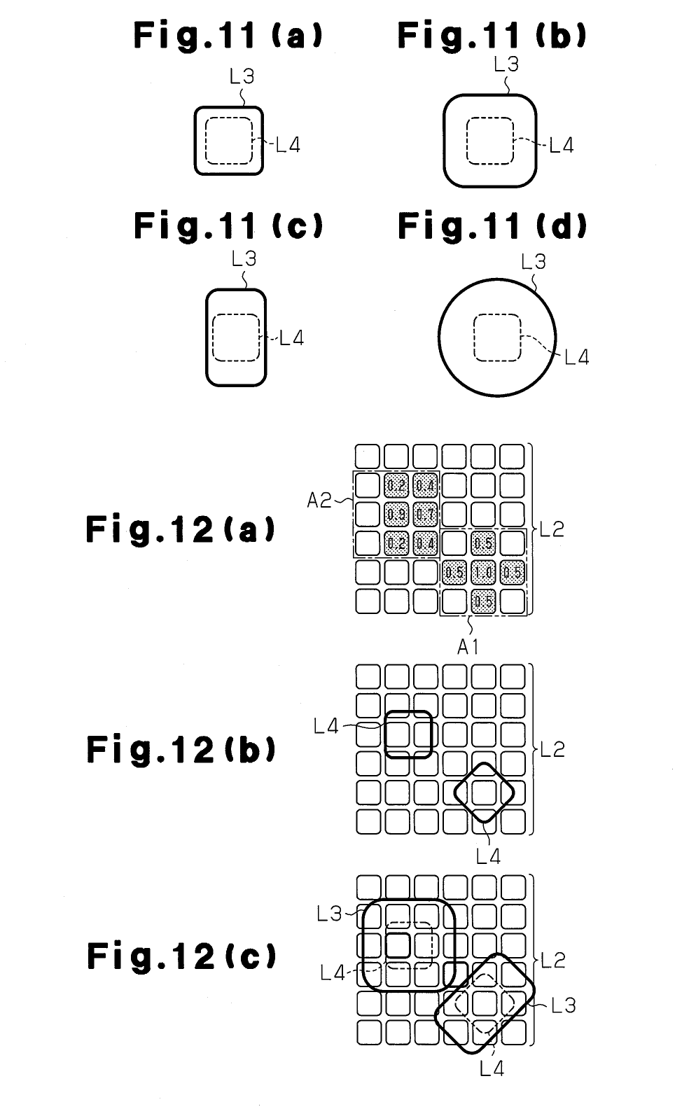

A fifth embodiment of a contactless power supplying system according to the present invention will now be described with reference to FIGS. 11 to 13. The contactless power supplying system of the fifth embodiment has substantially the same structure as the contactless power supplying system of the first embodiment shown in FIG. 1. The description hereafter will focus on differences from the first embodiment.

The contactless power supplying system of the fifth embodiment performs the presence detection with the primary verification coil L2. In other words, as shown by the double-dashed lines in FIG. 1, a voltage detection circuit 19 is connected to the primary verification coil L2. The voltage detection circuit 19 detects the voltage of the primary verification coil L2 and outputs the detection result to the common control circuit 12. In the same manner as the first embodiment, the common control circuit 12 sequentially supplies current to the primary verification coils L2, and performs the presence detection based on the detection result of the present voltage detection circuit 19.

As shown in FIGS. 11(a) to 11(d), power receiving device 30 includes secondary verification coils L4 having the same shape and power receiving coils L3 having different shapes. Specifically, the power receiving coil L3 shown in FIG. 11(a) is tetragonal and extends along the periphery of the secondary verification coil L4. The power receiving coil L3 shown in FIG. 11(b) is tetragonal and larger than the power receiving coil L3 of FIG. 11(a). The power receiving coil L3 shown in FIG. 11(c) is rectangular with a long side extending along the up to down direction as viewed in the drawing. The power receiving coil L3 shown in FIG. 11(d) is circular. In any one of the power receiving coils L3, the secondary verification coil L4 is positioned in the middle. The primary verification coil L2 corresponds to a primary communication coil, and the secondary verification coil L4 corresponds to a secondary communication coil.

The memory 34 of the power receiving device 30 stores, in advance, information related to the shape of the power receiving coil L3. The secondary control circuit 33 generates an information signal including the information related to the shape of the power receiving coil L3 stored in the memory 34 along with the ID signal and transmits, in a wireless manner, the ID signal and the information signal via the secondary verification circuit 32 and the secondary verification coil L4.

The primary verification circuit 18 demodulates the information signal received through the primary verification coil L2 and outputs the demodulated signal to the common control circuit 12. The common control circuit 12 recognizes the shape of the power receiving coil L3 based on the information signal.

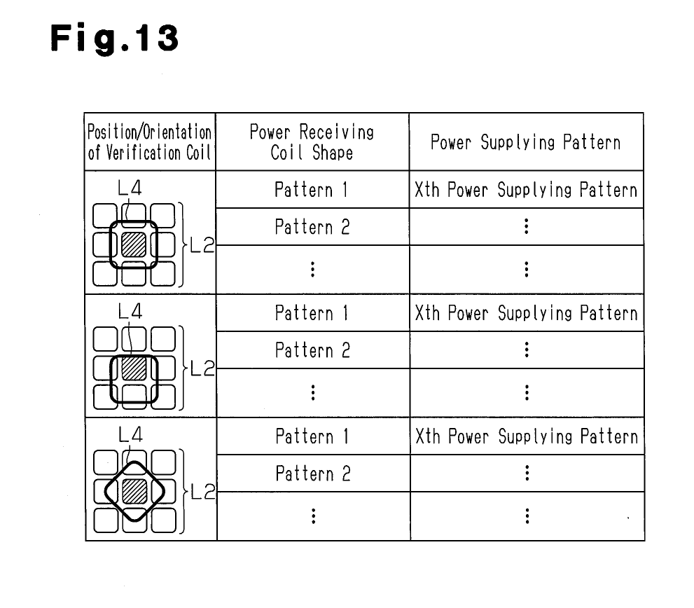

As shown in FIG. 13, the memory 14 stores a table showing the position and orientation of each secondary verification coil L4, and the power supplying pattern in which the output of the power receiving device 30 becomes maximal in the combination with each shape of the power receiving coil L3.

A case in which two power receiving devices 30 including power receiving coils L3 with different shapes are arranged will now be described. As shown in FIG. 12(a), the common control circuit 12 recognizes the presence detection level of the primary verification coil L2 through the voltage detection circuit 19. Then, as shown in FIG. 12(b), the common control circuit 12 selects the first area A1 and the second area A2 and calculates the difference degree R for each arrangement pattern with respect to each area in the same manner as the second embodiment. The arrangement pattern that is close to each secondary verification coil L4 is estimated by comparing the difference degrees R. The common control circuit 12 determines the data that is to be used for reference related to the position and orientation of the secondary verification coil L4 in the table of FIG. 13. The common control circuit 12 recognizes the shape of the power receiving coil L3 based on the received information signal and determines which pattern the shape of the power receiving coil L3 is in the table of FIG. 13 based on the recognized shape of the power receiving coil L3. Here, the position and orientation of the power receiving coil L3 can be recognized, as shown in FIG. 12(c). The common control circuit 12 determines the power supplying pattern in which the output of the power receiving device 30 becomes maximal with reference to the table of FIG. 13 and supplies power to the power supplying coil L1 in the power supplying pattern. Therefore, even if the power receiving devices 30 with power receiving coils L3 having different shapes are simultaneously arranged, the power supplying pattern in which the output of the power receiving device 30 becomes maximal is realized.

The fifth embodiment described in particular has the following advantage.

(6) Since the shape of the secondary verification coil L4 is the same, the size, the position and orientation of the power receiving coil L3, and furthermore, the power supplying pattern in which the output of the power receiving device 30 becomes maximal are recognized based on the position and orientation of the secondary verification coil L4 by acquiring the information related to the shape of the power receiving coil L3. Thus, the presence detection level does not need to be stored for every power receiving coil L3 having a different shape and for each position and orientation that differs for each shape, as shown in FIG. 10 of the fourth embodiment described above. Specifically, the presence detection level for every position and orientation that differs for the secondary verification coil L4 having the same shape merely needs to be stored. Moreover, the difference degree R does not need to be calculated for every power receiving coil L3 having a different shape and for every position and orientation that differ for each shape. Therefore, the processing load associated with the estimation of the position and orientation of the power receiving coil L3 in the common control circuit 12 is reduced. Therefore, an appropriate power supplying pattern is rapidly determined even if the shape of the power receiving coil L3 is different.

The embodiments described above may be modified in the following forms.

In the third embodiment, the difference degree R may be calculated for the presence detection level of each power supplying coil L1 in the fourth and fifth arrangement patterns (see FIG. 9) in which a plurality of power receiving coils L3 are arranged only when the number of power supplying coils L1, in which the presence detection level is greater than or equal to the threshold T1, is greater than or equal to the threshold. Thus, when the number of power receiving coil L3 is one, the number of power supplying coils L1 in which the presence detection level is greater than or equal to the threshold T1 becomes smaller than the threshold, and the calculation of the difference degree R for the fourth arrangement pattern and the fifth arrangement pattern is omitted. The process related to the determination of the installing position thus can be more rapidly performed.

In each embodiment described above, the ID matching is executed through exchange of ID request signal and ID signal, but this may be omitted. The verification circuits 18, 32 and the verification coils L2, L4 then can be omitted in the first to fourth embodiments.

In the first embodiment, the presence detection is performed through the voltage of the power supplying coil L1, but a coil for presence detection may be provided separate from the power supplying coil L1. This is the same in the second to fifth embodiments.

The power supplying pattern and the arrangement pattern in each embodiment described above are illustrative, and more patterns may be provided. For example, the arrangement pattern may be increased by rotating at an interval of 5° with the coil axis as the center of rotation with respect to the first arrangement pattern (see FIG. 3). When increasing a new arrangement pattern, the presence detection level in such arrangement pattern and the power supplying pattern in which the output of the power receiving device 30 in such arrangement pattern becomes maximal are stored in the memory 14.

In each embodiment described above, the power is supplied in the power supplying pattern in which the output of the power receiving device 30 becomes maximal. However, if the power required by the power receiving device 30 is small, the power may be supplied in the power supplying pattern in which the output is not a maximum.

For example, as shown in FIG. 3, assume that the power required by the power receiving device 30 is 9 W when estimated as being arranged in the first arrangement pattern. In this case, the power may be supplied in the first power supplying pattern in which 9 W can be ensured and the number of power supplying coils L1 that supply power is the least. The power to supply to the power supplying coil L1 thus can be suppressed.

In the second embodiment, the presence detection level of the portion where the first area A1 and the second area A2 overlap shown in FIG. 8(c) may be included in both areas A1, A2. In other words, in the example shown in FIG. 8(c), the presence detection levels “0.7” and “0.4” where the areas A1, A2 overlap are included in each area A1, A2.

In the second embodiment, a case where two power receiving coils L3 are adjacently arranged is described, but similar process can be performed in a case where three or more power receiving coils L3 are adjacently arranged. In other words, when three or more power receiving coils L3 are arranged, a new threshold is set based on the number of power supplying coils L1 in which the presence detection level becomes greater than or equal to the threshold T1. The common control circuit 12 thus can determine that three or more power receiving coils L3 are arranged based on the comparison between the number of power supplying coils L1 in which the presence detection level is greater than or equal to the threshold T1 and the new threshold. For example, if three power receiving coils L3 are adjacently arranged, the three top presence detection levels are recognized, and three areas having such presence detection levels as the center are selected. The process is then performed similar to the second embodiment.

In the first to fourth embodiments as well, the presence detection may be performed at the primary verification coil L2, similar to the fifth embodiment. In this case, the size and shape of the power receiving coil L3 and the secondary verification coil L4 are set to be equal.

In the first, second, and fourth embodiments, for example, the output power of the power receiving device 30 in the first to fifth power supplying patterns is stored for every arrangement pattern. However, only the power supplying pattern in which the output becomes maximal may be stored. In the third and fifth embodiments, not only the power supplying pattern in which the output becomes maximal, but also the output power in each power supplying pattern may be stored.

In the first to fifth embodiments, the presence detection is performed based on the voltage value of the power supplying coil L1 or the primary verification coil L2. However, the presence detection may be performed based on the current value of the power supplying coil L1 or the primary verification coil L2.

In the first to fifth embodiments, the position and orientation in the power receiving coil L3, and the like are estimated based on the calculated presence detection level. However, the process related to the estimation of the position and orientation in the power receiving coil L3 may be performed using the voltage value of the power supplying coil L1, and the like as is without calculating the presence detection level.

In each embodiment described above, the power receiving device 30 is provided in the portable terminal 40, but may be provided in other electric appliances. For example, the power receiving device 30 may be a configuration independent from the main body of the electric appliance.

In the fifth embodiment, the information signal related to the shape of the power receiving coil L3 is transmitted and received through the verification coils L2, L4. However, a dedicated communication coil may be arranged.

In each embodiment described above, the common control circuit 12 performs all the control, but a unit control circuit may be provided in each power supplying unit 15, and such unit control circuit may perform a part of the control. For example, the unit control circuit may supply power to the power supplying coil L1 based on a command signal from the common control circuit 12, or may transmit the ID request signal through the primary verification coil L2. The unit control circuit may calculate the presence detection level based on the detection result of the voltage detection circuit 17, and output the calculation result to the common control circuit 12. The unit control circuit may carry out the ID matching. The processing load of the common control circuit 12 thus can be reduced.

1. A contactless power supplying system comprising:
a power supplying device including a power supplying surface and a plurality of power supplying coils arranged along the power supplying surface, wherein each of the power supplying coils generates an alternating magnetic flux when supplied with alternating current; and
a power receiving device including a power receiving coil that generates inductive power supplied to a load based on the alternating magnetic flux when arranged on the power supplying surface, wherein
the power supplying device includes
a presence detection unit that detects whether or not the power receiving device is present opposing each of the power supplying coils,
a position-orientation estimation unit that estimates position and orientation of the power receiving coil relative to the power supplying surface based on a detection result of the presence detection unit,
a memory that stores a first table showing a relationship of a plurality of power supplying patterns, which correspond to the position and orientation of the power receiving coil in the power receiving device on the power supplying surface, and a power value of the inductive power generated by the power receiving coil in each of the power supplying patterns, and
a power supply control unit that selects the power supplying pattern having the highest power supplying efficiency in accordance with the position and orientation of the power receiving coil estimated by the position-orientation estimation unit based on the first table, wherein the power supply control unit supplies power in the selected power supplying pattern.

2. The contactless power supplying system according to claim 1, wherein
the presence detection unit detects a presence detection level of each power supplying coil that indicates a degree of magnetic coupling of each power supplying coil and the power receiving coil based on a voltage value or a current value in each power supplying coil of the power receiving device;
the position-orientation estimation unit that estimates the position and orientation of the power receiving coil based on a distribution of a plurality of presence detection levels of the power supplying coils.

3. The contactless power supplying system according to claim 2, wherein
the memory stores a second table showing a relationship of the position and orientation of the power receiving coil on the power supplying surface and the presence detection level of each power supplying coil;
the position-orientation estimation unit calculates a difference degree, which indicates a difference between the presence detection level of each power supplying coil in the second table stored in the memory and the presence detection level of each power supplying coil detected by the presence detection unit, and the position-orientation estimation unit estimates the position and orientation corresponding to the presence detection level at which the calculated difference degree becomes smallest as the position and orientation in which the power receiving coil is arranged.

4. The contactless power supplying system according to claim 2, wherein
based on a number of the power supplying coils opposing the power receiving coil detected by the presence detection unit, the position-orientation estimation unit determines a number of power receiving coils arranged on the power supplying surface,
the position-orientation estimation unit sequentially recognizes the same number of presence detection levels among the plurality of presence detection levels as the number of power receiving coils from larger presence detection levels when determined that a plurality power receiving coils are arranged, and
the position-orientation estimation unit selects the presence detection level of the power supplying coil in a region centered around the power supplying coils corresponding to the recognized presence detection levels and estimates the position and orientation of each power receiving coil based on the selected presence detection level of the power supplying coil.

5. The contactless power supplying system according to claim 2, wherein
the memory stores a second table showing a relationship of the presence detection level of each power supplying coil, when a plurality of power receiving coils are adjacently arranged at different positions and orientations, and power values of a plurality of inductive powers generated at the power receiving device by supplying power to each of the power supplying coils in the plurality of power supplying patterns when the plurality of power receiving coil are adjacently arranged at different positions and orientations; and
the power supply control unit selects the power supplying pattern having the highest power supplying efficiency for the position and orientation of one or more power receiving coils detected by the position-orientation estimation unit based on the second table stored in the memory, and the power supply control unit supplies power in the selected power supplying pattern.

6. The contactless power supplying system according to claim 2, wherein
the memory stores a second table showing a relationship of the presence detection level of each power supplying coil, when a plurality of power receiving coils having different shapes are adjacently arranged at different positions and orientations, and power values of the inductive power generated by each power receiving device in each power supplying pattern when the plurality of power receiving coils having different shapes are arranged at different positions and orientations;
the position-orientation estimation unit estimates the shape of the power receiving coil and the position and orientation of the power receiving coil based on the presence detection level of each power supplying coil; and
the power supply control unit selects the power supplying pattern having the highest power supplying efficiency for the shape, position, and orientation of the power receiving coil estimated by the position-orientation estimation unit based on the second table and supplies power in the selected power supplying pattern.

7. The contactless power supplying system according to claim 1, wherein
the power supplying device includes a plurality of primary communication coils each arranged in correspondence with the plurality of power supplying coils;
the power receiving device includes a secondary communication coil arranged in correspondence with the power receiving coil;
the presence detection unit detects the presence detection level of each of the primary communication coils that indicates a degree of magnetic coupling of the primary communication coil and the secondary communication coil based on a voltage value or a current value in the primary communication coil; and
the position-orientation estimation unit estimates the position and orientation of the secondary communication coil based on a distribution of a plurality of presence detection levels of the plurality of primary communication coils and estimates the position and orientation of the power receiving coil based on the position and orientation of the secondary communication coil.

8. The contactless power supplying system according to claim 7, wherein
the receiving device is one of a plurality of receiving devices;
the receiving devices include a plurality of power receiving coils having different shapes and a plurality of secondary communication coils having the same shape;
each power receiving device transmits, through wireless communication, an information signal related to the shape of the power receiving coil with the secondary communication coil;
the memory stores a second table showing a relationship of the plurality of power supplying patterns corresponding to the different shapes of the power receiving coils and the position and orientation of the secondary communication coils and a power value of the inductive power generated by the power receiving coil of each shape in each of the power supplying patterns; and
the power supply control unit receives the information signal from each receiving device, determines the shape of the power receiving coil based on the information signal, selects the power supplying pattern having the highest power supplying efficiency by referring to the second table based on the estimated position and orientation of the secondary communication coil and the determined shape of the power receiving coil, and supplies power in the selected power supplying pattern.

9. The contactless power supplying system according to claim 1, wherein the power supplying pattern of which the power supplying efficiency is high is the power supplying pattern in which an output power of the power receiving device is maximal.
